(19) United States
(12) Patent Application Publication
(10) Pub. No.: US 2018/0021828 A1
(43) Pub. Date: Jan. 25, 2018

(54) APPARATUS FOR INSPECTING AND SAMPLING A WOUND COIL OF METAL STRIP

(71) Applicant: Primetals Technologies Austria GmbH, Linz (AT)

(72) Inventors: Lukas PICHLER, Linz (AT); Alois SEILINGER, Linz (AT)

(21) Appl. No.: 15/549,396

(22) PCT Filed: Dec. 14, 2015
(86) PCT No.: PCT/EP2015/079612

§ 371 Date: Aug. 8, 2017

(30) Foreign Application Priority Data
Mar. 12, 2015 (EP) 15158747.4

(51) Int. Cl. B21C 51/00; B21C 47/34; G01N 1/04; B21C 47/22

(52) U.S. Cl. CPC B21C 51/00; B21C 47/22; B21C 47/3433; G01N 1/04

(57) ABSTRACT

Apparatus (1) for inspecting and sampling a wound coil (2) of metal strip (3) having a supporting arrangement for the wound coil (2). The supporting arrangement has at least two base rollers (4) arranged adjacent to one another. The rollers have roller axes (5) extending parallel to one another and onto which the coil (2) is placed for support. An inspection device (6) is arranged alongside the supporting arrangement. The inspection device (6) performs an inspection of the metal strip (3) at least when the metal strip (3) is a thin metal strip. A sampling device (10) arranged opposite the inspection device (6) with respect to the supporting arrangement, such that the supporting arrangement is located between the inspection device (6) and the sampling device (10). The sampling device (10) has a separating device (12) which takes a sample of the metal strip (3) when the metal strip (3) is a thick metal strip (3).

### CROSS-REFERENCE TO RELATED APPLICATIONS

The present application is a 35 U.S.C. §§ 371 national phase conversion of PCT/EP2015/079612,filed Dec. 14, 2015, which claims priority of European Patent Application No. 15158747.4, filed Mar. 12, 2015, the contents of which are incorporated by reference herein. The PCT International Application was published in the German language.

### TECHNICAL BACKGROUND

The present invention proceeds from a device for inspecting and sampling a wound coil of metal strip. That device has a mounting installation for a wound coil. The mounting device has at least two base rollers disposed beside one another which have roller axes which run so as to be mutually parallel and onto which the coil is placed for mounting. The device has an inspection device which is disposed lateral to the mounting installation. The inspection device is configured for inspecting the metal strip at least when the metal strip is a thin metal strip.

A device of this type is known, for example, from DE 44 11 905 A1. Sampling is performed in the case of this device.

A device for a wound coil of metal strip is known from AT 501 782 B1. The device has a mounting installation for a wound coil. The mounting installation has at least two base rollers that are disposed beside one another and have roller axes that run so as to be mutually parallel and onto which the coil is placed for mounting. The device has a sampling device which is disposed so as to be lateral to the mounting installation. The sampling device is configured for taking a specimen of the metal strip independently of whether the metal strip is a thin or a thick metal strip.

Further devices for inspecting and/or sampling a wound coil of metal strip are known from WO 2012/100 036 A1 and from WO 2012/126 631 A1, for example.

A device for inspecting and sampling a wound strip of metal strip, wherein the device has a mounting installation for the wound coil, the mounting installation has at least two base rollers that are disposed beside one another and have roller axes which run so as to be mutually parallel and onto which the coil is placed for mounting, the device has an inspection device which is disposed so as to be lateral to the mounting installation, and the inspection device is configured for performing an inspection of the metal strip, is known from EP 0 114 935 A1.

A device for sampling a wound strip of metal strip, wherein the device has a mounting installation for the wound coil, the mounting installation has at least two base rollers that are disposed beside one another and have roller axes which run so as to be mutually parallel and onto which the coil is placed for mounting, and the device has a sampling device which is configured for taking a specimen of the metal strip at least when the metal strip is a thick metal strip, is known from EP 0 044 923 A2.

The trend in rolling steel strip is toward a product mix of both conventional grades as well as of thick tube grades (thickness up to approx. 25 mm) and of high-tensile grades produced in the same rolling mill.

Inspection of the respective metal strip is to some extent required for conventional grades in the range of thin strips (for example having a thickness of up to 6 mm). Part of the already wound metal strip is unwound on a roller table in order for the inspection to be carried out. A visual inspection is performed, and in many cases a specimen is removed as well. A hydraulically driven cutter is usually used for removing the specimen.

For tube grades and often also for high-tensile grades, it is necessary for a specimen to be taken after the metal strip produced has been wound and for the specimen to be checked and tested. However, the cutter for severing a specimen of a thin metal strip is not suitable for this. It is therefore necessary for a suitable sampling device for thick metal strips to be provided for this purpose.

### SUMMARY OF THE INVENTION

The object of the present invention is to refine a device of the type mentioned at the outset in such a manner that both thin metal strips can be inspected as well as samples can be taken from thick metal strips in a simple and effective manner by means of the device.

According to the invention, a device of the type mentioned above is designed so that in addition to the inspection device, the device has a sampling device which, in relation to the mounting installation, is disposed so as to be opposite the inspection device such that the mounting device is located between the inspection device and the sampling device. The sampling device has a separation device that is configured for taking a specimen of the metal strip at least when the metal strip is a thick metal strip.

A thin metal strip is typically considered to be a metal strip having a thickness of approx. 0.8 mm to approx. 6 mm. A thick metal strip is typically considered to be a metal strip having a thickness of approx. 12 mm to approx. 25 mm. Depending on the design embodiment of the inspection device and of the sampling device, a metal strip having a thickness between 6 mm and 12 mm can be classified as a thin metal strip, as a thick metal strip, or be classified in an arbitrary manner, depending on requirements.

The inspection device for removing a specimen of a thin metal strip and/or for severing a portion of the metal strip to be inspected typically has a cutter. The cutter may be hydraulically driven. In an individual case, a design embodiment without a cutter is also possible.

The separation device may be configured as a plasma cutting machine or as a rotating cutting disk, for example.

The sampling device preferably has a threading aid for infeeding a thick metal strip to the separation device. The threading aid enables the thick metal strip to be infed to the separation device in a reliable manner. In particular, the threading aid may be configured as a roller that can be brought to bear on the thick metal strip. The roller can be driven or not driven, depending on requirements.

The device preferably has a downholding roller that may be placed from above on the coil. The downholding roller may hold the coil in the mounting installation in a particularly reliable manner. Furthermore, any undesirable bursting open of the coil can be prevented. Furthermore, a sufficiently high pressure may be exerted on the coil by means of the downholding roller such that sufficiently high friction and adhesion of the coil on the base rollers is guaranteed in particular for a thick metal strip to be unwound.

The downholding roller can be driven or not driven, depending on requirements. Turning and rotating of the coil can in particular be facilitated and supported by a driven downholding roller.

Preferably, at least one of the base rollers is driven. Turning and rotating of the coil can thereby be carried out in a particularly simple manner.

The device preferably has a single strapping device which causes both a coil composed of a thick metal strip and a coil composed of a thin metal strip to be strapped. This enables one strapping device to be saved, as compared to the prior art. Alternatively, the strapping device together with the mounting installation, the inspection device and the sampling device may be formed in one functional unit. In this case, the coil is strapped while it is located on the base rollers. Alternatively, the strapping unit may be a dedicated functional unit. In this case, the coil is lifted off the base rollers, transported to the strapping device and strapped therein.

The properties, features and advantages of this invention described above, as well as the manner in which said properties, features and advantages are achieved, will be understood more clearly and more explicitly in conjunction with the description hereunder of the exemplary embodiments which will be explained in more detail in conjunction with a drawing in which.

### DESCRIPTION OF THE DRAWING

The drawing is a schematic illustration of a device for inspecting and sampling a wound coil of metal strip.

### DESCRIPTION OF AN EMBODIMENT

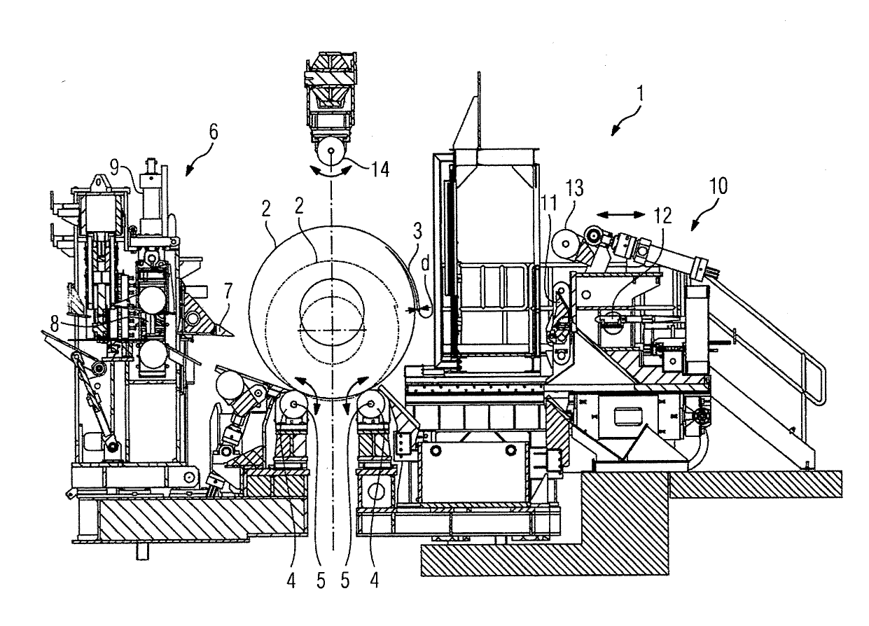

Coils 2 of metal strip 3 are to be inspected and sampled in a device 1. In FIG. 1, a coil 2 having a maximum diameter is plotted using a solid line, and a coil 2 having a minimum diameter is plotted using chain-dotted lines. Each metal strip 3 may be a steel strip. The metal strip 3 has a strip thickness d which varies from one coil 2 to another coil 2. The strip thickness d is for example, at minimum approx. 1 mm. In an individual case, the strip thickness d may also be slightly less than 1 mm. The strip thickness d is for example at a maximum of approx. 25 mm. In individual cases, the strip thickness d may be even slightly more than 25 mm.

In principle, the strip thickness d may be anywhere between 1 mm and 25 mm. However, the strip thickness d is typically either below 6 mm or above 12 mm. A metal strip 3 having a strip thickness d of less than 6 mm is referred to herein as a thin metal strip, while a metal strip 3 having a strip thickness d of more than 12 mm is referred to herein as a thick metal strip. Depending on the design embodiment of the device 1, a metal strip 3 having a strip thickness d between 6 mm and 12 mm may alternatively be classified either as a thin or a thick metal strip. That classification may be predefined by the further design embodiment of the device 1. Alternatively, the classification of the metal strip 3 as a thin or a thick metal strip may be performed on an individual basis, as explained below.

The respective coil 2 is infed to the device 1 by a transportation installation (not illustrated). The transportation installation may be configured as a known coil transportation carriage, for example or in the transportation installation can also be configured in another manner. The respective coil 2 is placed onto a mounting installation for the wound coil 2. The mounting installation has at least two, typically exactly two, base rollers 4. The base rollers 4 are disposed beside one another. The rollers have roller axes 5 running parallel to one another. The respective coil 2 is placed onto the base rollers 4 for mounting. At least one of the base rollers 5 is typically driven. This is indicated by double arrows at the base rollers 4.

The device 1 has an inspection device 6 disposed so as to be lateral to the mounting installation. The inspection device 6 is configured for performing an inspection of the metal strip 3 at least when the metal strip 3 is a thin metal strip. Two alternative designs are substantially possible.

The inspection device 6 may have one holding element and one cutter 8. One end of the metal strip 3 is gripped by the holding element when the metal strip 3 is being unwound. After a few meters have been unwound, the unwound portion of the metal strip 3 is severed by the cutter 8. The holding element is lifted such that the unwound portion hangs in a vertical manner. Both sides of the unwound portion in this state can be visually inspected. The inspection per se can either be performed in an automated manner by means of a camera, or directly by an operator on site. The unwound portion is scrapped after the inspection.

On the other hand, the inspection device 6 may have a table or a roller table onto which the unwound portion of the metal strip 3 is conveyed. In this case, only the upper side of the unwound portion can be inspected. However, since the lower side of the portion is the external side of the coil 2, the lower side of the portion is therefore inspected directly during unwinding. In this case, it is possible, but not mandatory, for the inspection device 6 to have a cutter 8. If the cutter 8 is present, it removes a specimen of a thin metal strip 3.

The inspection device 6 is configured for performing an inspection and, optionally, also a sampling of the metal strip 3 when the metal strip 3 has a material thickness of up to 6 mm, for example. The inspection device 6 may be capable of carrying out a sampling of the metal strip 3 only when the metal strip 3 has a strip thickness d of 6 mm maximum. Alternatively, the inspection device 6 to be able may additionally carry out an inspection and optionally also a sampling of the metal strip 3 when the metal strip 3 has a strip thickness d of more than 6 mm, for example of up to 10 mm or up to 12 mm.

For the metal strip 3 to be readily unwound, the inspection device 6 furthermore has a separator 7 which is capable of being brought to bear on the respective coil 2 such that the separator may engage in the gap between the outermost coiling of the wound coil 2 and the successive inner coiling, such that the separator may lift the outermost coiling from the wound coil 2. The metal strip 3 is unwound by a short piece once the separator 7 has been introduced into the gap. The unwound portion of the metal strip 3 is at least visually inspected, as has already been mentioned. The inspection device 6 for this purpose has the inspection table mentioned (not illustrated).

When the cutter 8 is present, the cutter 8 is activated by a cutter drive 9. In this case, a specimen of a thin metal strip can be removed by means of the cutter 8. The cutter drive 9 can be configured as electric or hydraulic. The latter is indicated by the illustration of the cutter drive 9 as a hydraulic cylinder. The cutter 8 and the cutter drive 9 be dimensioned and operable such that a metal strip 3 may be severed by the cutter 8 only when the metal strip 3 has a strip thickness d which does not exceed a maximum strip thickness for a thin metal strip. As has already been mentioned, the maximum strip thickness for a thin metal strip may be, for example, 6 mm or more, for example 8 mm, 10 mm, or 12 mm.

In addition to the inspection device 6, the device 1 has a sampling device 10 configured for taking a specimen of the metal strip 3 at least when the metal strip 3 is a thick metal strip. The sampling device 10 is configured for sampling the metal strip 3 when the metal strip 3 has a material thickness of at least 12 mm, for example. The sampling device 10 may be capable of sampling the metal strip 3 exclusively when the metal strip 3 has a strip thickness d of at least 12 mm. Alternatively, the sampling device 10 may be able to additionally sample the metal strip 3 having a strip thickness d of less than 12 mm, for example, at least 10 mm or of at least 8 mm.

It is possible that a metal strip 3 may be neither inspected in the inspection device 6 nor be sampled in the sampling device 10, if the strip thickness d of the metal strip 3 is within a specific range of values. For example, this may occur when a metal strip 3 can be inspected by the inspection device 6 only when the metal strip 3 has a strip thickness d of 6 mm maximum or 8 mm maximum. A metal strip 3 may then be sampled by the sampling device 10 only when the metal strip 3 has a strip thickness d of at least 12 mm or at least 10 mm. Other values are also possible.

Alternatively, depending on its strip thickness d it is also possible for a metal strip 3 at all times either be inspected in the inspection device 6 or alternatively be sampled in the sampling device 10. This may occur when a metal strip 3 may be inspected by the inspection device 6 only when the metal strip 3 has a strip thickness d up to a limit thickness, and a metal strip 3 can be sampled by the sampling device 10 can be sampled only when the metal strip 3 has a strip thickness d of at least the limit thickness. The limit thickness herein can be, for example, 6 mm, 8 mm, 10 mm, or 12 mm, depending on requirements. Other values are possible here too.

Again, depending on the strip thickness d, it is alternatively possible for a metal strip 3 at all times to be inspected in the inspection device 6 or to be sampled in the sampling device 10, whereas it is also selectable in many cases whether the metal strip 3 is inspected in the inspection device 6 or is sampled in the sampling device 10. This can be the case, for example, when a metal strip 3 can be inspected by means of the inspection device 6 when the metal strip 3 has a strip thickness d of 10 mm maximum, and a metal strip 3 can be sampled by means of the sampling device 10 when the metal strip 3 has a strip thickness d of at least 8 mm. Other values are also possible.

The sampling device 10, like the inspection device 6, is disposed lateral to the mounting installation. In relation to the mounting installation, the sampling device is disposed opposite the inspection device 6. The mounting installation (in particular the base rollers 4) are thus located between the inspection device 6 and the sampling device 10.

A specimen of the metal strip 3 is intended at all times to be removed by the sampling device 10. In order for a specimen of this type to be removed, as is indicated by a double arrow, the sampling device 10, in its entirety, is capable of being moved up to the coil 2. The sampling device 10 likewise has a separator 11. In a manner analogous to the separator 7, the separator 11 is introduced into the gap between the outermost coiling of the wound coil 2 and the successive inner coiling.

This may lift the outermost coiling from the wound coil 2. The coil 2 is unwound by a short piece when the separator 7 has been introduced into the gap. The unwound portion of the coil 2 is then severed from the remaining metal strip 3 by a separation device 12 of the sampling device 10, and a respective specimen is removed. The separation device 12 may be configured as a plasma cutting machine, corresponding to the Figure. Alternatively, the separation device 12 can be configured as a rotating cutting disk, for example.

The winding of the metal strip 3 is often performed while the metal strip 3 is still hot. In this case, the temporal profile of the cooling of the metal strip 3 in the interior of the wound coil 2 is different from that in the outermost coiling of the coil 2. In a case of this type, the outermost coiling of the coil 2 often has material properties that are different from those of the other coilings of the coil 2. In removal of a specimen, it may thus be necessary for one or more pieces of scrap to be severed before a representative specimen can be taken.

In many cases, the specimen taken is a slat which extends across the entire width of the metal strip 3. However, this is not mandatory. Another design of the separation device 12, may remove a specimen of any other shape by the separation device 12.

Independently of its remaining design embodiment, the sampling device 10 has a threading aid 13. The threading aid 13 feeds a thick metal strip 3 to the separation device 12. The threading aid 13 may be configured as a roller, corresponding to the illustration. The roller is capable of being brought to bear on the metal strip 3. The roller 13 is preferably not driven, but alternatively, the roller 13 may be driven.

The device 1 preferably has a downholding roller 14. The downholding roller 14 can be applied from above on the coil 2. The downholding roller 14 secures a coil 2 that is disposed on the base rollers 4. The downholding roller 14 is rotatable. As is indicated in the drawing by a double arrow, the downholding roller 14 may be driven. Alternatively, the downholding roller 13 may be configured as a non-driven roller.

The device 1 further has a single strapping device which is not shown in the drawing. A coil 2 may be strapped by the strapping device, in a manner known per se. Strapping of the respective coil 2 is performed following the inspection in the inspection device 6, or following sampling in the sampling device 10, respectively. The coil 2 can be strapped in the strapping device independently of whether the metal strip 3 of which the coil 2 is composed is a thick metal strip or a thin metal strip.

In summary, the present invention thus relates to the following circumstances:

A device 1 for inspecting and sampling a wound coil 2 of metal strip 3 has a mounting installation for the wound coil 2. The mounting installation has at least two base rollers 4 that are disposed beside one another and have roller axes 5 that entered mutually parallel and onto which the coil 2 is placed for mounting. The device 1 has an inspection device 6 which is disposed so as to be lateral to the mounting installation. The inspection device 6 is configured for performing an inspection of the metal strip 3 at least when the metal strip 3 is a thin metal strip. In addition to the inspection device 6, the device 1 has a sampling device 10 which in relation to the mounting installation is disposed so as to be opposite the inspection device 6, such that the mounting installation is located between the inspection device 6 and the sampling device 10. The sampling device 10 has a separation device 12 which is configured for taking a specimen of the metal strip 3 at least when the metal strip 3 is a thick metal strip.

The present invention has many advantages. In particular, coils 2 of thin metal strip 3 can be inspected, and coils 2 of thick metal strip 3 can be sampled in the same device 1. Furthermore, only a single transportation installation is required for the coils 2, independently of the further design embodiment of the former. Also, the strapping device has to be present only once. As a result, the investment costs are therefore significantly reduced.

While the invention has been illustrated and described in more detail by way of the preferred exemplary embodiment, the invention is not limited to the examples disclosed, and other variants can be derived therefrom by a person skilled in the art without departing from the scope of the invention.

### LIST OF REFERENCE SIGNS

1 Device
2 Coils
3 Metal strip
4 Base rollers
5 Roller axes
6 Inspection device
7 Separator
8 Cutter
9 Cutter drive
10 Sampling device
11 Separator
12 Separation device
13 Threading aid
14 Downholding roller
d Strip thickness

1. A device for inspecting and sampling a wound coil of metal strip, comprising:
a mounting installation for the wound coil;
at least two base rollers disposed beside one another, the base rollers have roller axes which run mutually parallel and onto which the coil is placed for mounting and which enable the coil to be rotated;
an inspection device disposed lateral to the mounting installation and configured for performing an inspection of the metal strip at least when the metal strip is a thin metal strip;
a sampling device disposed opposite the inspection device such that the mounting device is located between the inspection device and the sampling device;
the sampling device includes a separation device configured for taking a specimen of the metal strip at least when the metal strip is a thick metal strip.

2. The device as claimed in claim 1, further comprising the inspection device includes a cutter configured for at least one of removing a specimen of a thin metal strip and for severing a portion of the thin metal strip to be inspected.

3. The device as claimed in claim 1, further comprising the separation device is configured as a plasma cutting machine or as a rotating cutting disk.

4. The device as claimed in claim 1, further comprising the sampling device comprises a threading aid configured for infeeding a thick metal strip to the separation device.

5. The device as claimed in claim 4, wherein the threading aid is configured as a roller that can be brought to bear on the thick metal strip.

6. The device as claimed in claim 1, further comprising a downholding roller configured and operable to be placed from above on the coil.

7. The device as claimed in claim 6, wherein the downholding roller is driven or not driven.

8. The device as claimed in claim 1, further comprising at least one of the base rollers is driven.

9. The device as claimed in claim 1, further comprising a single strapping device configured for strapping either of a coil comprised of a thick metal strip and a coil that is comprised of a thin metal strip that can be strapped.
